(19) United States
(12) Patent Application Publication
(10) Pub. No.: US 2010/0245282 A1
(43) Pub. Date: Sep. 30, 2010

(54) TOUCH-SCREEN BASED INPUT METHOD AND SYSTEM, AND ELECTRONIC DEVICE USING SAME

(75) Inventor: Cheng-Nan Lai, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/436,097

(22) Filed: May 5, 2009

(30) Foreign Application Priority Data
Mar. 24, 2009 (CN) 200910301075.2

(51) Int. Cl. G06F 3/045

(52) U.S. Cl. 345/174

(57) ABSTRACT

An input method based upon a multi-touch screen and for use in an electronic device is disclosed. Firstly, a lookup table is stored. The lookup table includes commands and groups of inputs, where each command is associated with a group of inputs. Two touch signals of two inputs are detected. If the two touch signals are detected at the same time, corresponding locations of the two inputs are detected too. Otherwise, the two touch signals are cleared. A group of inputs are determined based upon the two touch signals and the two touch locations. Then, a command is looked up using the determined group of inputs and the lookup table. Finally, the command is inputted to the electronic device.

### BACKGROUND

1. Technical Field

The present disclosure relates to a touch-screen based input method and system, and an electronic device using the same.

2. Description of Related Art

Touch screens are now widely used in electronic devices and, accordingly, many input systems and methods based upon a touch screen have been developed. These conventional systems and methods typically associate predetermined areas of the touch screen with corresponding commands, and users need to identify and locate a desired area to input a desired command. This is inconvenient.

Therefore, it is desirable to provide a touch-screen based input method and system, and an electronic device, which can overcome the above-mentioned problems.

### BRIEF DESCRIPTION OF THE DRAWINGS

FIG. 1 a functional block diagram of an electronic device, according to an exemplary embodiment.

FIG. 2 is a flowchart of a touch-screen based input method, according to another exemplary embodiment.

### DETAILED DESCRIPTION

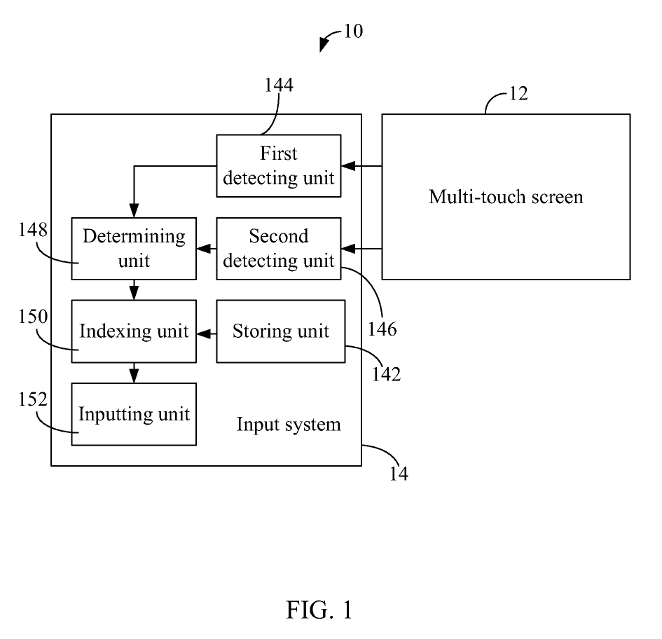

Referring to FIG. 1, an electronic device 10, according to an exemplary embodiment, includes a multi-touch screen 12 and an input system 14. The electronic device 10 can be a desktop or laptop computer, a satellite navigation device, a mobile phone, a camera, or a gaming device. The multi-touch screen 12 can be a liquid crystal display (LCD) based touch screen.

The input system 14 includes a storing unit 142, a first detecting unit 144, a second detecting unit 146, a determining unit 148, an indexing unit 150, and an inputting unit 152. The storing unit 142 is configured for storing a lookup table (see below). The lookup table includes commands and groups of inputs, where each command is associated with a group of inputs. The first detecting unit 144 is configured for detecting a first touch signal and a first touch location of a first input, i.e., a first touch on the multi-touch screen 12. The second detecting unit 146 is configured for detecting a second touch signal and a second touch location of a second input, i.e., a second touch on the multi-touch screen 12. The determining unit 148 is configured for determining a group of input according to the first touch signal, the second touch signal and relationship between the first touch location and the second touch location if the first touch signal and the second touch signal are detected at the same time. The indexing unit 150 is configured for indexing a command corresponding to the determined group of inputs using the lookup table. The inputting unit 152 is configured for inputting the indexed command to the electronic device 10, e.g., a central processor of the electronic device 10 (not shown).

Various components of the input system 14 such as the storing unit 142, the first detecting unit 144, the second detecting unit 146, the determining unit 148, the indexing unit 150, and the inputting unit 152 can be individual electrical elements, or alternatively integrated into a central control unit. The components can connect to each other by an input/output (I/O) bus to allow required communication therebetween. Also, some components can be software modules written in a variety of computer languages such as C#, Visual C++, Visual Basic, and C++, and executed on hardware to realize corresponding functions.

Using the input system 14, commands are input by analyzing the location relationship of two simultaneous inputs onto the multi-touch screen 12. As such, users are free from identifying and locating desired areas during inputting.

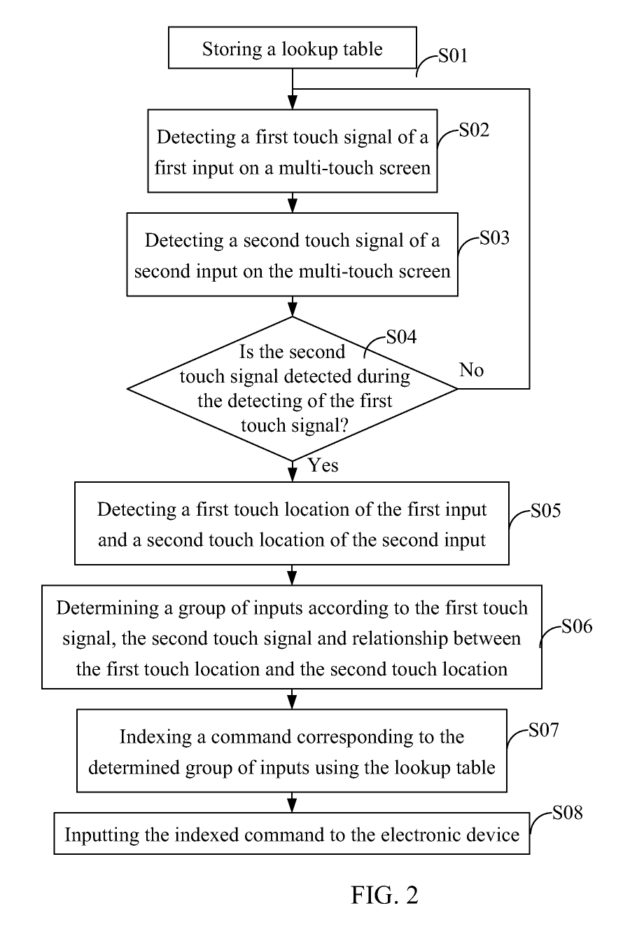

Referring to FIG. 2, an input method, according to another exemplary embodiment, can be executed by the electronic device 10 and includes steps S01-S08:

In step S01, a lookup table is built and stored in the storing unit 142. The lookup table includes commands and groups of inputs, where each command is associated with a group of inputs.

In step S02, a first touch signal of a first input is detected by the first detecting unit 144. It should be mentioned that the first touch signal will be cleared from the first detecting unit 144 once the first input is removed from the multi-touch screen 12.

In step S03, a second touch signal of a second input is detected by the second detecting unit 146. It also should be mentioned that the second touch signal will be cleared from the second detecting unit 146 once the second input is removed from the multi-touch screen 12.

In step S04, whether the second touch signal is detected during the detecting of the first touch signal is determined by the determining unit 148. If yes, go to step S05, if no, go back to step S02.

In step S05, a first touch location of the first input is detected by the first detecting unit 144 and a second touch location of the second input is detected by the second detecting unit 146.

In step S06, a group of inputs according to the first touch signal, the second touch signal and relationship between the first touch location and the second touch location, is determined by the determining unit 148.

In step S07, a command corresponding to the determined group of inputs is indexed by the indexing unit 150 and using the lookup table.

In step S08, the indexed command is inputted to the electronic device 10 by the inputting unit 152.

To provide better understanding of the input method, detailed examples of the input method is given below, but it should be noted that the input method is not limited by these examples. In the examples, the electronic device 10 is a mobile phone having a camera module.

### EXAMPLE 1

In this example, the lookup table stored in step S01 is:

| Groups of inputs | Associated commands |
|---|---|
| A first input and a second input | Display a menu |
| above the first input | |
| A first input and a second input | Display a menu |
| below the first input | |
| A first input and a second input at | Display a menu |
| the left side of the first input | |
| A first input and a second input at | Display a menu |
| the right side of the first input | |

The first input detected in step S02 is a long press. The second input detected in step S03 is a tap.

### EXAMPLE 2

In this example, the lookup table stored in step S01 is:

| Groups of inputs | Associated commands |
|---|---|
| A first input and a second input at | Power off the |
| the left side of the first input | electronic device |
| A first input and a second input at | Display a menu |
| the right side of the first input | |

The first touch detected in step S02 is a long press. The second input detected in step S03 is a double-tap.

### EXAMPLE 3

In this example, the lookup table stored in step S01 is:

| Groups of inputs | Associated commands |
|---|---|
| A first input and a second input at | Zoom in an image |
| the left side of the first input | |
| A first input and a second input at | Zoom out an image |
| the right side of the first input | |

The first touch detected in step S02 is a long press. The second input detected in step S03 is a tap.

### EXAMPLE 4

In this example, the lookup table stored in step S01 is:

| Location relationships | Associated commands |
|---|---|
| A first input and a second input | Display a previous |
| above the first input | image |
| A first input and a second input | Display a next image |
| below the first input | |
| A first input and a second input at | Rotate an image |
| the left side of the first input | counter clockwise |
| A first input and a second input at | Rotate an image |
| the right side of the first input | clockwise |

The first touch detected in step S02 is a long press. The second input detected in step S03 is a scroll (i.e., tap and move across the multi-touch screen 12).

While the disclosure has been described by way of example and in terms of preferred embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch-screen based input method for use in an electronic device, comprising:
storing a lookup table, the lookup table comprising a collection of commands and a collection of groups of inputs, where each command is associated with a group of inputs;
detecting a first touch signal of a first input on a multi-touch screen;
detecting a second touch signal of a second input;
determining whether the second touch signal is detected during the detecting of the first touch signal;
detecting a first touch location of the first input and a second touch location of the second input if the second touch signal is detected during the detecting of the first touch signal;
determining a group of inputs according to the first touch signal, the second touch signal and relationship between the first touch location and the second touch location;
indexing a command corresponding to the determined group of inputs using the lookup table; and
inputting the indexed command to the electronic device.

2. The touch-screen based input method as claimed in claim 1, wherein the first input is a long press.

3. The touch-screen based input method as claimed in claim 1, wherein the second input is selected from the group consisting of a tap, a double-tap and a scroll.

4. The touch-screen based input method as claimed in claim 1, wherein the commands comprise powering off the electronic device, displaying a menu on the multi-touch screen, and opening a file stored in the electronic device.

5. The touch-screen based input method as claimed in claim 1, wherein the first touch is a long press, the second input is a tap, and the lookup table is:

| Groups of inputs | Associated commands |
|---|---|
| A first input and a second input | Display a menu |
| above the first input | |
| A first input and a second input | Display a menu |
| below the first input | |
| A first input and a second input at | Display a menu |
| the left side of the first input | |
| A first input and a second input at | Display a menu |
| the right side of the first input | |

6. The touch-screen based input method as claimed in claim 1, wherein the first touch is a long press, the second input is a double-tap, and the lookup table is:

| Groups of inputs | Associated commands |
|---|---|
| A first input and a second input at | Power off the |
| the left side of the first input | electronic device |
| A first input and a second input at | Display a menu |
| the right side of the first input | |

7. The touch-screen based input method as claimed in claim 1, wherein the first touch is a long press, the second input is a tap, and the lookup table is:

| Groups of inputs | Associated commands |
|---|---|
| A first input and a second input at | Zoom in an image |
| the left side of the first input | |
| A first input and a second input at | Zoom out an image |
| the right side of the first input | |

8. The touch-screen based input method as claimed in claim 1, wherein the first touch is a long press, the second input is a scroll, and the lookup table is:

| Location relationships | Associated commands |
|---|---|
| A first input and a second input | Display a previous |
| above the first input | image |
| A first input and a second input | Display a next image |
| below the first input | |
| A first input and a second input at | Rotate an image |
| the left side of the first input | counter clockwise |
| A first input and a second input at | Rotate an image |
| the right side of the first input | clockwise |

9. A touch-screen based input system for use in an electronic device, comprising:
a storing unit configured for storing a lookup table, the lookup table comprising a collection of commands and a collection of groups of inputs, where each command is associated with a group of inputs;
a first detecting unit configured for detecting a first touch signal and a first touch location of a first input on a multi-touch screen;
a second detecting unit configured for detecting a second touch signal and a second touch location of a second input on the multi-touch screen;
a determining unit configured for determining a group of inputs according to the first touch signal, the second touch signal, and relationship between the first touch location and the second touch location if the first touch signal and second touch signal are detected at the same time;
an indexing unit configured for indexing a command corresponding to the determined group of inputs using the lookup table; and
an inputting unit configured for inputting the indexed command to the electronic device.

10. An electronic device comprising:
a multi-touch screen; and
an input system, comprising:
a storing unit configured for storing a lookup table, the lookup table comprising a collection of commands and a collection of groups of inputs, where each command is associated with a group of inputs;
a first detecting unit configured for detecting a first touch signal and a first touch location of a first input on a multi-touch screen;
a second detecting unit configured for detecting a second touch signal and a second touch location of a second input on the multi-touch screen;
a determining unit configured for determining a group of inputs according to the first touch signal, the second touch signal, and relationship between the first touch location and the second touch location if the first touch signal and the second touch signal are detected at the same time;
an indexing unit configured for indexing a command corresponding to the determined group of inputs using the lookup table; and
an inputting unit configured for inputting the indexed command.
